(19) United States
(12) Patent Application Publication
(10) Pub. No.: US 2013/0140497 A1
(43) Pub. Date: Jun. 6, 2013

(54) CARBON-LITHIUM TRANSITION METAL PHOSPHATE COMPOSITE MATERIAL HAVING A LOW CARBON CONTENT

(71) Applicants: Gerhard Nuspl, Munchen (DE); Nicolas Tran, Nandlstadt (DE); Christian Vogler, Moosburg (DE); Christoph Stinner, Munchen (DE)

(72) Inventors: Gerhard Nuspl, Munchen (DE); Nicolas Tran, Nandlstadt (DE); Christian Vogler, Moosburg (DE); Christoph Stinner, Munchen (DE)

(73) Assignee: SUD-CHEMIE IP GMBH & CO. KG, Munchen (DE)

(21) Appl. No.: 13/700,312

(22) PCT Filed: May 26, 2011
(86) PCT No.: PCT/EP11/58626

§ 371 Date: Feb. 22, 2013

(30) Foreign Application Priority Data
May 27, 2010 (DE) 10 2010 021 804.9

(51) Int. Cl. H01M 4/136

(52) U.S. Cl. CPC H01M 4/136
USPC 252/507; 252/506; 252/509

(57) ABSTRACT

The present invention relates to a composite material containing particles of a lithium transition metal phosphate and carbon with a carbon content of ≦1.4 wt.-%. The present invention further relates to an electrode containing the composite material and a secondary lithium-ion battery containing an electrode comprising the composite material.

The present invention relates to a composite material containing particles of a lithium transition metal phosphate and carbon with a carbon content of ≦1.4 wt.-%. The present invention further relates to electrodes for secondary lithium-ion batteries containing the composite material according to the invention.

Doped and non-doped mixed lithium metal oxides have recently received attention in particular as electrode materials in so-called “lithium-ion batteries”.

For example, non-doped or doped mixed lithium transition metal phosphates have been used as cathode material, in particular as cathode material in electrodes of secondary lithium-ion batteries, since papers by Goodenough et al. (U.S. Pat. No. 5,910,382). To produce the lithium transition metal phosphates, both solid-state syntheses and also so-called hydrothermal syntheses from aqueous solution are proposed. Meanwhile, almost all metal and transition metal cations are known from the state of the art as doping cations.

Thus WO 02/099913 describes a method for producing LiMPO₄, wherein M, in addition to iron, is (are) one or more transition metal cation(s) of the first transition metal series of the periodic table of the elements, in order to produce phase-pure optionally doped LiMPO₄.

EP 1 195 838 A2 describes the production of lithium transition metal phosphates, in particular LiFePO₄, by means of a solid-state process, wherein typically lithium phosphate and iron (II) phosphate are mixed and sintered at temperatures of approximately 600° C.

Further methods for producing in particular lithium iron phosphate have been described for example in Journal of Power Sources 119 to 121 (2003) 247 to 251, JP 2002-151082 A as well as in DE 103 53 266 A1.

Conductive carbon black is usually added to the thus-obtained doped or non-doped lithium transition metal phosphate and it is processed to cathode formulations. Thus EP 1 193 784 A1, EP 1 193 785 A1 as well as EP 1 193 786 A1 describe so-called carbon composite materials of LiFePO₄ and amorphous carbon which, when producing iron phosphate from iron sulphate, sodium hydrogen phosphate, also serves as reductant for residual Fe³⁺ residues in the iron sulphate as well as to prevent the oxidation of Fe²⁺ to Fe³⁺. The addition of carbon is also intended to increase the conductivity of the lithium iron phosphate active material in the cathode. Thus in particular EP 1 193 786 A1 indicates that not less than 3 wt.-% carbon must be contained in the lithium iron phosphate carbon composite material in order to achieve the necessary capacity and corresponding cycle characteristics of the material.

EP 1 049 182 B1 proposes to solve similar problems by coating lithium iron phosphate with amorphous carbon.

However, high requirements apply for the rechargeable lithium-ion batteries provided for use today in particular also in cars, in particular in relation to their discharge cycles as well as their capacity.

However, the materials or material mixtures proposed thus far have yet to achieve the required electrode density, as they do not display the required compressed powder density. The compressed density of the material can be correlated approximately to the electrode density or the density of the so-called active material as well as the battery capacity. The higher the compressed density, the higher also the capacity of the battery.

Therefore, the object of the present invention was to provide an improved electrode material, in particular an improved cathode material, for secondary lithium-ion batteries which has in particular an improved compressed density compared with the materials of the state of the art.

The object of the present invention is achieved by a composite material containing particles of a lithium transition metal phosphate and carbon, with a carbon content of 1.4 wt.-%, in preferred embodiments 0.5 to 1.3 wt.-%, more preferably 0.7 to 1.3 wt.-% and in yet another embodiment more than 0.9 to 1.3 wt.-%.

Surprisingly, the composite material according to the invention has compressed densities which, compared with the usual electrode materials of the state of the art, display an improvement of approximately 5% and more. This effect would, without being bound to a particular statement, have to be attributed to the low carbon content.

By increasing the compressed density, a higher electrode density is made possible, with the result that the capacity of a battery (measured via the volumetric energy density of the cathode) also increases approximately by a factor of 5% and more when the composite material according to the invention is used as active material in the cathode of a secondary lithium-ion battery.

This finding is all the more surprising as, according to the invention, much smaller quantities of carbon are contained in the composite material than were previously considered necessary according to the state of the art for the production of an industrially usable electrode containing the composite material.

The term “a lithium transition metal phosphate” means within the framework of the present invention that the lithium transition metal phosphate is present doped or non-doped.

“Non-doped” means that pure, in particular phase-pure, lithium transition metal phosphate is used. The transition metal is preferably selected from the group consisting of Fe, Co, Mn or Ni or mixtures thereof, thus has for example the empirical formulae LiFePO₄, LiCoPO₄, LiMnPO₄ or LiNiPO₄.

By a doped (in other words “mixed substituted”) lithium transition metal phosphate is meant a compound of the formula LiM′_{y}M″ₓPO₄, wherein M″=Fe, Co, Ni or is Mn, M′ is different from M″ and represents at least one metal cation from the group consisting of Co, Ni, Mn, Fe, Nb, Ti, Ru, Zr, B, Mg, Zn, Ca, Cu, Cr, Sr, Ir or combinations thereof, but preferably represents Co, Ni, Mn, Fe, Ti, B, Mg, Zn and Nb, x is a number <1 and >0.01 and y is a number >0.001 and <0.99. Typical preferred compounds are e.g. LiNb_{y}FeₓPO₄, LiMg_{y}FeₓPO₄ LiB_{y}FeₓPO₄ LiMn_{y}FeₓPO₄, LiCo_{y}FeₓPO₄, LiMn_{z}Co_{y}FeₓPO₄ with 0≦x, y, z≦1).

In further embodiments of the invention, this term also includes compounds of the formula

LiFeₓMn_{1-x-y}M_{y}PO₄

in which M is a divalent metal from the group Sn, Pb, Zn, Mg, Ca, Sr, Ba, Co, Ti and Cd and wherein: x<1, y<0.3 and x+y<1. Particularly preferred in this class of compounds as divalent metal M is Zn, Mg or Ca, still more preferably Zn and Mg.

In all the above-named mixed lithium transition metal phosphates, the doping metal ions are present preferably in a quantity of from 0.05 to 3 wt.-%, preferably 1-3 wt.-%, relative to the total lithium transition metal phosphate. The doping metal cations occupy either the lattice positions of the metal or of the lithium. Exceptions to this are mixed Fe, Co, Mn, Ni mixed phosphates which contain at least two of the above-named elements, in which larger quantities of doping metal cations may also be present, in the extreme case up to 50 wt.-%.

The carbon in the composite material can be present according to the invention as pure pyrocarbon and/or elementary carbon, wherein pyrocarbon is preferred.

The term “elementary carbon” means here that particles of pure carbon which may be both amorphous and crystalline but form discrete particles (in the form of spheres, such as e.g. spheroidal graphite, flakes, grains etc.) can be used. Examples of amorphous carbon are e.g. Ketjenblack, acetylene black, carbon black etc. However, within the framework of the present invention a crystalline elementary carbon allotrope is preferably used in further embodiments. Examples of this are graphite, carbon nanotubes as well as the class of compounds of fullerenes and mixtures thereof. Also, so-called VGCF carbon (vapour grown carbon fibres) is just as preferred as the crystalline allotropes.

The term “pyrocarbon” denotes within the framework of the invention the presence of an uninterrupted, continuous layer on the particles of the lithium transition metal phosphate of non-crystalline carbon which contains no discrete carbon particles.

The pyrocarbon is obtained by heating, i.e. pyrolysis of precursor compounds at temperatures of below 1500° C., preferably below 1200° C. and more preferably of below 1000° C. and most preferably of below 800° C. At higher temperatures of in particular >1000° C. an agglomeration of the particles on the lithium transition metal phosphates due to so-called “fusion” often occurs, which typically leads to a poor current-carrying capacity of the composite material according to the invention. Important here is only that no crystalline ordered synthetic graphite forms, the production of which requires temperatures of at least 2800° C. at normal pressure.

Typical precursor compounds are for example carbohydrates such as lactose, sucrose, glucose, starch, polymers such as for example polystyrene butadiene block copolymers, polyethylene, polypropylene, aromatic compounds such as benzene, anthracene, toluene, perylene, higher alcohols such as glycols and polyglycols as well as all other compounds known as suitable per se for the purpose to a person skilled in the art.

The exact temperature also depends on the specific mixed lithium transition metal phosphate to be coated, as individual lithium transition metal phosphates often already decompose to phosphides at temperatures of about 800° C.

The layer thickness of the pyrocarbon coating is advantageously 2-15, preferably 2-10 and quite particularly preferably 2-5 nm, wherein the layer thickness can be set selectively in particular by the type and starting concentration of the precursor material, the exact choice of temperature and duration of the heating.

As already stated above, it is possible in particular embodiments of the invention that both pyrocarbon and elementary carbon are present in the composite material according to the invention. The proportion of the respective type of carbon is at least 10% of the total carbon content.

The bulk density of the composite material according to the invention is more than 600 g/l, in further embodiments more than 650 g/l, in still further embodiments more than 700 g/l. This contributes to the increase in the compressed density of an electrode containing the composite material according to the invention as active material and thus also increases its capacity. It has been shown that this parameter is particularly well-suited to the characterization of electrode active material.

The BET surface area of the composite material according to the invention is ≦12.5 m²/g (measured according to DIN ISO 9277:2003-05), whereby, if processed to an electrode, less binder is needed than in the case of a material with larger BET surface area. Small BET surface areas further have the advantage that the compressed density and thus the electrode density, consequently also the capacity of a battery, is increased.

The compressed density of the composite material according to the invention is >2.2 g/cm³, preferably the compressed density lies in a range of from 2.2 to 3.5 g/cm³. Due to these values for the compressed density, clearly higher electrode densities result in an electrode containing the composite material according to the invention than in the case of materials of the state of the art, with the result that the capacity of a battery also increases if such an electrode is used.

With a monomodal particle-size distribution, the D₁₀ value of the composite material is preferably ≦0.30 μm, the D₅₀ value preferably ≦0.70 μm and the D₉₀ value≦5.00 μm.

As already stated above, the small particle size of the composite material according to the invention leads, when used as active material in an electrode in a battery, to a higher current density and also to a better cycle stability. Of course, the composite material according to the invention can also be ground even more finely, should this be necessary for a specific use. The grinding process is carried out using methods known per se to a person skilled in the art.

The powder resistance of the composite material according to the invention is preferably <70 Ω·cm, quite particularly preferably <50 Ω·cm, whereby a battery containing an electrode with the composite material according to the invention is also characterized by a particularly high current-carrying capacity.

The composite material according to the invention is produced by methods known per se, comprising the steps of
a) providing particles of a lithium transition metal phosphate
b) optionally, adding a precursor compound for pyrocarbon and optionally elementary carbon particles to form a mixture
c) compacting the mixture from step b)
d) heating the compacted mixture.

As already stated above, the lithium transition metal phosphate for use in the method according to the invention may be present both doped and non-doped.

According to the invention it is unimportant how the synthesis of the lithium transition metal phosphate was carried out before use in the method according to the invention. In other words the lithium transition metal phosphate can be obtained both within the framework of a solid-state synthesis or also within the framework of a so-called hydrothermal synthesis, or also via any other method.

However, it has been shown that a lithium transition metal phosphate which was obtained by hydrothermal route is particularly preferably used in the method according to the invention and in the composite material according to the invention, as this often has fewer impurities than one obtained by solid-state synthesis.

As already mentioned above, almost all organic compounds which can be converted to carbon under the reaction conditions of the method according to the invention are suitable as precursor compounds for the pyrocarbon.

Preferred within the framework of the method according to the invention are in particular carbohydrates such as lactose, sucrose, glucose, starch or mixtures thereof, quite particularly preferably lactose, further higher alcohols such as glycols, polyglycols, polymers such as for example polystyrene butadiene block copolymers, polyethylene, polypropylene, aromatic compounds such as benzene, anthracene, toluene, perylene as well as mixtures thereof and all other compounds known as suitable per se for the purpose to a person skilled in the art.

When using carbohydrates, these are used, in preferred embodiments, in the form of an aqueous solution, or, in an advantageous development of the present invention, water is then added after mixing the carbon with the lithium transition metal phosphate and/or the elementary carbon, with the result that a slurry is obtained, the further processing of which is preferred in particular from production engineering and emission points of view compared with other method variants.

Other precursor materials such as for example benzene, toluene, naphthalene, polyethylene, polypropylene etc. can be used either directly as pure substance or in an organic solvent.

Typically, within the framework of the method, a slurry is formed which is then dried before carrying out the compacting at a temperature of from 100 to 400° C.

The compacting of the dry mixture itself can take place as mechanical compaction e.g. by means of a roll compactor or a tablet press, but can also take place as rolling, build-up or wet granulation or by means of any other technical method appearing suitable for the purpose to a person skilled in the art.

After compacting the mixture from step b), in particular the dried mixture, the mixture is quite particularly preferably sintered at ≦800° C., even more preferably at ≦750° C., as already stated above in detail, wherein the sintering takes place preferably under protective gas atmosphere. Under the chosen conditions no graphite forms from the precursor compounds for pyrocarbon, but a continuous layer of pyrocarbon which partly or completely covers the particles of the lithium transition metal phosphate does form.

Although pyrocarbon still forms from the precursor compound over a wide temperature range at higher temperatures during sintering, the particle size in particular of the particles of the lithium transition metal phosphate increases through caking, which brings with it the disadvantages described above.

Nitrogen is used as protective gas during the sintering or pyrolysis for production engineering reasons, but all other known protective gases such as for example argon etc., as well as mixtures thereof, can also be used. Technical-grade nitrogen with low oxygen contents can equally also be used. After heating, the obtained product is finely ground in order to then find use as starting product for producing an electrode.

The object of the present invention is further achieved by an electrode, in particular a cathode, for a secondary lithium-ion battery containing the composite material according to the invention as active material. A higher electrode active material density in the electrode after formulation is also achieved because of the increased compressed density of the composite material according to the invention.

Typical further constituents of an electrode are, in addition to the active material, conductive carbon blacks as well as a binder. Any binder known per se to a person skilled in the art can be used as binder, such as for example polytetrafluoroethylene (PTFE), polyvinylidene difluoride (PVDF), polyvinylidene difluoride hexafluoropropylene copolymers (PVDF-HFP), ethylene-propylene-diene terpolymers (EPDM), tetrafluoroethylene hexafluoropropylene copolymers, polyethylene oxides (PEO), polyacrylonitriles (PAN), polyacryl methacrylates (PMMA), carboxymethylcelluloses (CMC), and derivatives and mixtures thereof.

Within the framework of the present invention typical proportions of the individual constituents of the electrode material are preferably 80 to 95 parts by weight active material, i.e. of the composite material according to the invention, 10 to 2.5 parts by weight conductive carbon and 10 to 2.5 parts by weight binder.

Because of the composite material according to the invention, which already contains carbon, in particular in the present case the quantity of conductive carbon in the formulation of the electrode can also be clearly reduced compared with the lithium transition metal phosphate electrodes of the state of the art.

In still further embodiments of the present invention, it is possible, despite the surprisingly low carbon content of the composite material, to entirely avoid the addition of so-called conductive carbon in the electrode formulation. A typical electrode formulation in this case is 90 to 95 parts by weight active material and 10 to 5 parts by weight, preferably 5 parts by weight, binder.

The electrode according to the invention typically has a compressed density of >1.9 g/cm³, preferably >2.2 g/cm³, particularly preferably >2.3 g/cm³. The specific capacity of an electrode according to the invention is approximately 150 mA/g at a volumetric energy density of >300 mAh/cm³, more preferably >350 mAh/cm³. Values up to 390 mAh/cm³ are likewise obtained according to the invention.

The object of the present invention is further achieved by a secondary lithium-ion battery containing an electrode according to the invention as cathode, with the result that a battery with higher electrode density (or density of the active material) is obtained having a higher capacity than previously known secondary lithium-ion batteries, whereby the use of such lithium-ion batteries, in particular in cars, with simultaneously smaller measurements of the electrode or battery as a whole is also possible.

Cathode-anode pairs with a cathode containing the composite material according to the invention as active material (hereinafter only the empirical formula of the lithium transition metal phosphate is given) are, without being understood as limiting, e.g. LiFePO₄//Li₄Ti₅O₁₂ with a single cell voltage of approximately 1.9 V, which is very suitable as substitute for lead-acid cells or LiCo_{z}Mn_{y}FeₓPO₄//Li₄Ti₅O₁₂ with increased cell voltage and improved energy density.

The invention is explained in more detail below with the help of figures and some examples which are not to be understood as limiting the scope of the present invention.

There are shown in:

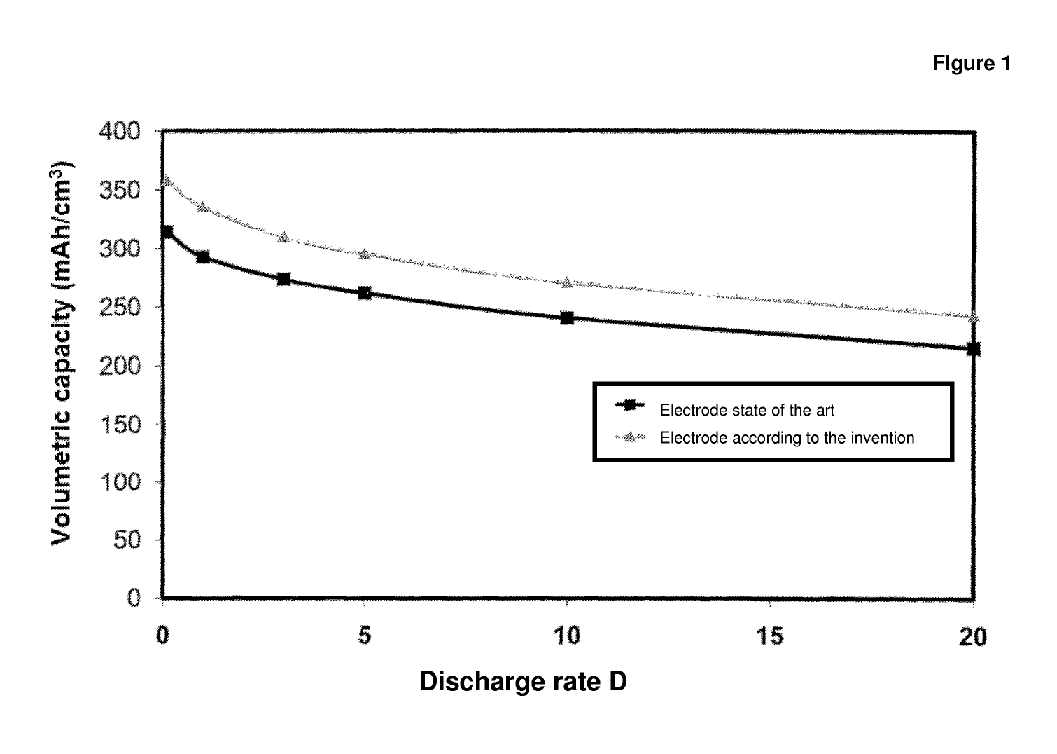

FIG. 1: The specific capacity of an electrode according to the invention depending on the C-rate compared with an electrode of the state of the art.

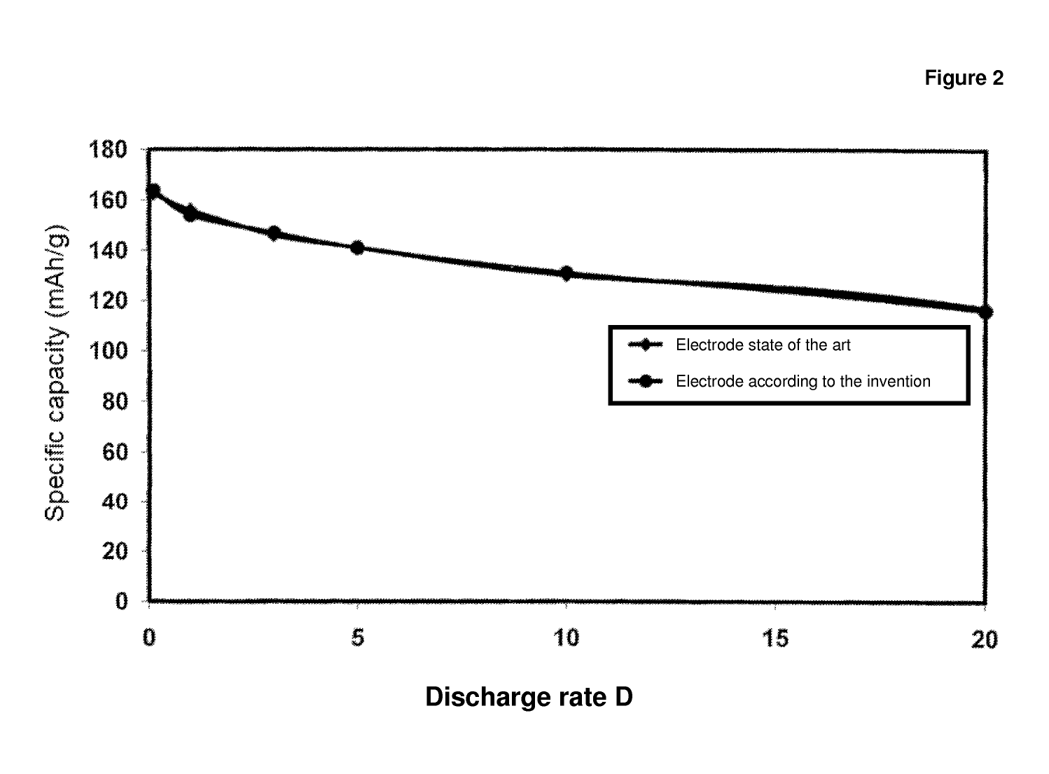

FIG. 2: The volumetric capacity of an electrode according to the invention compared with an electrode of the state of the art.

### 1. MEASUREMENT METHODS

The BET surface area was determined according to DIN ISO 9277:2003-05.

The particle-size distribution was determined according to ISO 13320:2009 by means of laser granulometry with a Malvern Mastersizer 2000.

The compressed density and the powder resistance were determined simultaneously with a Mitsubishi MCP-PD51 tablet press with a Loresta-GP MCP-T610 resistance meter, which are installed in a glovebox charged with nitrogen to exclude potentially disruptive effects of oxygen and moisture. The tablet press was hydraulically operated via a manual Enerpac PN80-APJ hydraulic press (max. 10,000 psi/700 bar).

A 4-g sample was measured using the settings recommended by the manufacturer.

The powder resistance is then calculated according to the following equation:

Powder resistance [Ω/cm]=resistance [Ω]×thickness [cm]×RCF

The RCF value is equipment-dependent and was, according to the value settings of the manufacturer, given as 2.758 in this case.

The compressed density is calculated according to the following formula:

$$Compressed density ( g \text{/} {cm}^{3} ) = \frac{mass of the sample ( g )}{\prod \times {r}^{2} ( {cm}^{2} ) \times thickness of the sample ( in cm )}$$

r=radius of the sample tablet

Customary error tolerances are 3% at most.

Determination of the Density of the Active Material in an Electrode

To determine the material density of the active material (i.e. of the composite material according to the invention) electrodes (thickness approximately 60 μm) composed of 90% active material, 5 wt.-% conductive carbon black and 5 wt.-% binder were produced.

For this

2.0 g 10% PVDF solution in NMP (N-methylpyrrolidone), 5.4 g NMP, 0.20 g Super P Li (Timcal) conductive carbon black, 3.6 g composite material according to the invention from Examples 1 and 2 or comparison material from comparison examples 1 to 5 were weighed into a 50-ml screw-lid jar and mixed for 5 minutes at 600 rpm, dispersed for 1 min with a Hielscher UP200S ultrasound finger and then, after adding 20 glass beads with a diameter of 4 mm and sealing the glass, rotated at a speed of 10 rpm on a roller table for at least 15 hours. To coat the electrode, the thus-obtained homogeneous suspension was applied to an aluminium carrier foil with a laboratory coating knife with a 200-μm gap width and a feed rate of 20 mm/sec. After drying at 80° C. in the vacuum drying cupboard, electrodes with a diameter of 13 mm were punched out of the foil and mechanically post-compacted at room temperature on a Specac uniaxial hydraulic laboratory press at a load of 10 t for 60 sec. To determine the density the net electrode weight was determined from the gross weight and the known unit weight of the carrier foil and the net electrode thickness determined with a micrometer screw less the known thickness of the carrier foil.

The active material density in g/cm³ in the electrode is calculated from

(active material portion in electrode formulation (90%)*electrode net weight in g/(π(0.65cm)²*net electrode thickness in cm)

### EXAMPLE 1

### Composite Material According to the Invention Containing LiFePO₄

283.4 kg of a fresh filter cake of lithium iron phosphate (187.6 dry weight with 66.2% solids content) produced by hydrothermal synthesis (according to WO 2005/051840), 9.84 kg lactose monohydrate corresponding to 52.5 g per kg lithium iron phosphate were placed in a horizontal EMT 5501 ploughshare mixer with cutter head. Then, 80 litres of deionized water were added via an internal spray head and mixing carried out over 15 min at a rotation speed of 140 RPM of the horizontal wave and 1500 RPM of the cutter head.

In order to prevent agglomerates, the slurry was then passed through a Probst & Class micronizer/cone mill and spray-dried in a Stork & Bowen dryer with atomizer nozzle at a gas entry temperature of 350° C. and an exit temperature of 125° C. at an atomization pressure of 6.0 bar. The dry product was then mechanically granulated. For this, an Alexanderwerk WP 50N/75 roller compactor was used at a roll pressure of 35 bar and a roll speed of 8 rpm and a feed device speed of 30 rpm. The compacted samples were granulated in a horizontal screen rotor mill with 2.5-mm screen insert and separated from the dust portion on a vibrating screen with 0.6-mm mesh size.

The thus-obtained light-grey granules were then calcined under nitrogen in a gas-tight Linn chamber furnace under protective gas at a temperature of 750° C. and at a heating-up and holding time of 3h each. In total, a final carbon content of the whole composite material of 1.14 wt.-% results.

The granules, now black, were then ground on an Alpine AFG 200 grinder with 5.0-mm grinding nozzles at a grinding pressure of 2.5 bar.

### EXAMPLE 2

### Composite Material According to the Invention Containing LiFePO₄

The composite material according to the invention was synthesized as in Example 1, except that 10.96 kg lactose monohydrate was added, in order to obtain a product with a total carbon content of 1.27 wt.-%.

### COMPARISON EXAMPLE 1

283.4 kg of a fresh filter cake of lithium iron phosphate (187.6 dry weight with 66.2% solids content) produced by hydrothermal synthesis (according to WO 2005/051840), 14.67 kg lactose monohydrate corresponding to 78.3 g per kg lithium iron phosphate or approximately 1.7 wt.-% resulting pyrocarbon were placed in a horizontal EMT 5501 ploughshare mixer with cutter head. Then, 80 litres of deionized water were added via an internal spray head and mixing carried out over 15 min at a rotation speed of 140 RPM of the horizontal wave and 1500 RPM of the cutter head.

In order to prevent agglomerates, the slurry was then passed through a Probst & Class micronizer/cone mill and spray-dried in a Stork & Bowen dryer with atomizer nozzle at a gas entry temperature of 350° C. and an exit temperature of 125° C. at an atomization pressure of 6.0 bar. The dry product was then mechanically granulated. For this, an Alexanderwerk WP 50N/75 roller compactor was used at a roll pressure of 35 bar and a roll speed of 8 rpm and a feed device speed of 30 rpm. The compacted samples were granulated in a horizontal screen rotor mill with 2.5-mm screen insert and separated from the dust portion on a vibrating screen with 0.6-mm mesh size.

The thus-obtained light-grey granules were then calcined under nitrogen in a gas-tight Linn chamber furnace under protective gas at a temperature of 750° C. and at a heating-up and holding time of 3h each.

The granules, now black, were then ground on an Alpine AFG 200 grinder with 5.0-mm grinding nozzles at a grinding pressure of 2.5 bar.

### COMPARISON EXAMPLE 2

As further reference to the composite material according to the invention from Example 1, the lithium iron phosphate was treated as in Example 1 or comparison example 1, but mixed with 105 g lactose monohydrate per kg lithium iron phosphate dry material, with the result that the total carbon content resulting after calcination was 2.25 wt.-% (as pyrocarbon).

### COMPARISON EXAMPLES 3 TO 5

Comparison examples 3 to 5 were carried out as in the above synthesis of the composite material of the examples and comparison examples, wherein the quantity of lactose monohydrate added was varied so as to obtain the carbon contents given in Table 1 for the respective composite materials.

The physical parameters of the composite material according to the invention from Example 1 as well as of the comparison examples together with electrical properties of an electrode containing the composite materials as active material are shown in Table 1.

TABLE 1

| | | | | | | | | | Specific | |
|---|---|---|---|---|---|---|---|---|---|---|
| | | | | | | | | | capacity | Volumetric |
| | | Bulk | | | | | Powder | Compressed | C/12, 25° C. | energy |
| | Carbon | density | d10 | d50 | d90 | BET | resistance | density | 2.9-4.0 V | density |
| Example | [wt.-%] | (g/l) | [μm] | [μm] | [μm] | [m²/g] | (Ω · cm) | (g/cm³) | (mAh/g) | (mAh/cm³) |
| CE 4 | 0.70 | 493 | 0.19 | 0.39 | 1.29 | 10.1 | >10⁷ | 1.77 | 97 | 172 |
| CE 5 | 0.87 | 501 | 0.19 | 0.59 | 2.21 | 10.4 | 1035.84 | 1.79 | 149 | 267 |
| 1 | 1.14 | 711 | 0.21 | 0.56 | 2.03 | 11.4 | 44.47 | 2.40 | 150 | 360 |
| 2 | 1.27 | 737 | 0.22 | 0.63 | 2.01 | 11.8 | 40.21 | 2.34 | 151 | 353 |
| CE 3 | 1.44 | 666 | 0.20 | 0.46 | 1.96 | 12.5 | 27.61 | 2.31 | 151 | 349 |
| CE 1 | 1.70 | 653 | 0.19 | 0.46 | 2.13 | 12.8 | 24.97 | 2.15 | 152 | 327 |
| CE 2 | 2.25 | 528 | 0.18 | 0.39 | 3.06 | 16.2 | 21.84 | 2.11 | 153 | 323 |

As can be seen from Table 1, the composite material according to the invention of Examples 1 and 2 has a significant increase in bulk density compared with the comparison examples. The maximum in the range according to the invention for the carbon content compared with lower and higher carbon contents is remarkable. A clear increase in the compressed density (correlated with the active material density of the electrode) is likewise obvious.

The volumetric energy density of an electrode is also at its highest when using composite material according to the invention as electrode active material compared with the material of the comparison examples.

As can be seen from FIG. 1, the specific capacity of the active material from composite materials according to the invention of Examples 1 and 2 is roughly the same compared with the active material of an electrode made from the material of comparison examples 1 to 3 and 5. The specific capacity now stays the same with a still further reduction of the carbon content (comparison example 4). The volumetric capacities (energy densities) of the electrode, on the other hand, are clearly different from each other, as can be seen from FIG. 2 and the values in Table 1.

The volumetric energy density is calculated according to the following equation:

compressed powder density=active material density in electrode (g/cm³)×specific capacity (g/cm³)×specific capacity

1. Composite material containing particles of a lithium transition metal phosphate and carbon with a carbon content of ≦1.4 wt.-%, the BET surface area of which is ≦12.5 m²/g and the compressed density of which is >2.2 g/cm³.

2. Composite material according to claim 1, wherein the transition metal is Fe, Co, Mn or Ni or mixtures thereof.

3. Composite material according to claim 2, wherein the lithium transition metal phosphate is doped with foreign atoms.

4. Composite material according to claim 3, wherein the foreign atoms are selected from Mg, Zn, Ca, B, Bi, Nb, Ta, Zr, Ti, Hf, V, W, Mo, Ru, Cu, Ag, Au, Ir.

5. Composite material according to claim 1, wherein the carbon is pyrocarbon and/or elementary carbon.

6. Composite material according to claim 5, wherein the pyrocarbon is present in the form of a coating on the particles of the lithium transition metal phosphate.

7. Composite material according to claim 6, wherein the layer thickness of the pyrocarbon coating lies in the range of from 2 to 15 nm.

8. Composite material according to claim 5, wherein the elementary carbon is a crystalline allotrope of carbon, selected from graphite, carbon nanotubes, fullerenes, as well as mixtures thereof or is VGCF carbon.

9. Composite material according to one of the previous claims claim 1, the bulk density of which is >600 g/l.

10. (canceled)

11. (canceled)

12. Composite material according to claim 1, wherein the compressed density lies in a range of from 2.2 to 3.5 g/cm³.

13. Composite material according to claim 1, the powder resistance of which is <70 Ω·cm.

14. Electrode for a secondary lithium-ion battery with an active material containing the composite material according to claim 1.

15. Secondary lithium-ion battery comprising an electrode according to claim 14.
